(19) United States
(12) Patent Application Publication
(10) Pub. No.: US 2004/0067785 A1
(43) Pub. Date: Apr. 8, 2004

(54) Miniaturized telecommunication device

(76) Inventor: Frank Lillie, Munchen (DE)

Correspondence Address: BELL, BOYD & LLOYD, LLC, P. O. BOX 1135, CHICAGO, IL, 60690-1135, US

(21) Appl. No.: 10/468,666

(22) PCT Filed: Jan. 28, 2002
(86) PCT No.: PCT/DE02/00289

(30) Foreign Application Priority Data
Feb. 19, 2001 (DE) 101 07 702.5

(51) Int. Cl. H04B 7/15

(52) U.S. Cl. 455/575.6; 455/11.1

(57) ABSTRACT

The invention relates to a telecommunication device comprising a fastening element for fastening the device on a support, especially a bracelet (1). The telecommunication device is further provided with a housing (2), at least one sensor for detecting a force (or turning moment) that is effective between the housing (2) and the fastening element (1), and a processor (29) for controlling the function of the telecommunication device in accordance with the force detected by the sensor.

The present invention relates to a miniaturized telecommunications device.

Owing to increasing integration of the components of mobile telecommunications devices, the accompanying reduced power consumption of the devices, and advances in the technology of the mains-independent batteries required for operation, it is possible to build ever smaller and lighter telecommunications devices. Progressive miniaturization of these devices is in itself desirable so as to make it as convenient as possible for users to carry the devices with them. One problem with miniaturization, however, arises from usability: in order to activate the functions of a telecommunications device, i.e. to receive or initiate a call, dial the number for a call etc., the user needs to press buttons on such a device. Miniaturization thus hits a limit when the size of these buttons and their separation becomes smaller than the finger tips of a user, so that this user can no longer easily ascertain which of a number of adjacent buttons he is pressing.

One option for overcoming this problem is to assign two or more functions to one button, as is known in particular from electronic pocket calculators. This solution is unsatisfactory, however, because it increases the number of button-pressing actions required to activate a given function.

The object of the present invention is thus to create a mobile telephone whose functions can be selected with a reduced number of buttons, without the number of actions that a user needs to perform to select a particular function increasing compared with a traditional button phone.

The object is achieved by a telecommunications device having the features of claim 1.

Whereas with a traditional mobile telecommunications device the housing is held in the hand by the user when selecting a function, and can be regarded as stationary while the buttons are moved in relation to the housing, in the telecommunications device according to the invention the housing itself can take on the function of a button in a generalized sense, in that a force acting between the housing and the fastening element, or a turning moment acting between the housing and the fastening element, is detected by a sensor and evaluated by a processor, in order to control the function of the telecommunications device according to the wishes of a user. The detection of a force also includes here the detection of a movement.

In order to be able to control as large a number of functions as possible in a simple way, it is advantageous to provide a plurality of sensors to detect forces or turning moments in a plurality of spatial directions.

According to a preferred embodiment, the fastening element has a base plate to which the housing is connected, and a sensor for detecting a turning moment about an axis normal to the base plate and/or one or more sensors for detecting a turning moment about one or more axes parallel to the base plate are provided as sensors.

As an alternative or in addition to the turning-moment sensors, sensors can also be provided for detecting a displacement of the housing relative to the base plate, preferably for detecting displacements in one or more directions parallel to the base plate.

In order to be able to exclude the unintentional activation of the displacement-activated functions of the telecommunications device, means are preferably provided to lock the displacement of the housing.

According to a simple embodiment, a sensor can be implemented as a switch contact that closes an electrical contact after displacement by a preset distance or if a given turning moment is exceeded. It can also be advantageous, however, to equip the telecommunications device with a plurality of sensors supplying a quantitative signal and with a processor that is set up to determine a quantitative ratio of the signals supplied by the sensors. This enables a large number of functions to be controlled with a relatively small number of sensors.

In a preferred embodiment, it is provided that markings assigned to the digits 0 to 9 are made on the edge of a face of the housing that faces away from the fastening element, and thus is easily visible to the user. The displacement or the turning moment that is applied to the housing by pressing one such marking can be detected using the sensors and assigned to a selected digit by the processor. The fastening element is preferably designed as a bracelet, so that the telecommunications device according to the invention can be worn on the wrist by the user.

Further features and advantages of the present invention follow from the following description of exemplary embodiments with reference to the enclosed figures, in which

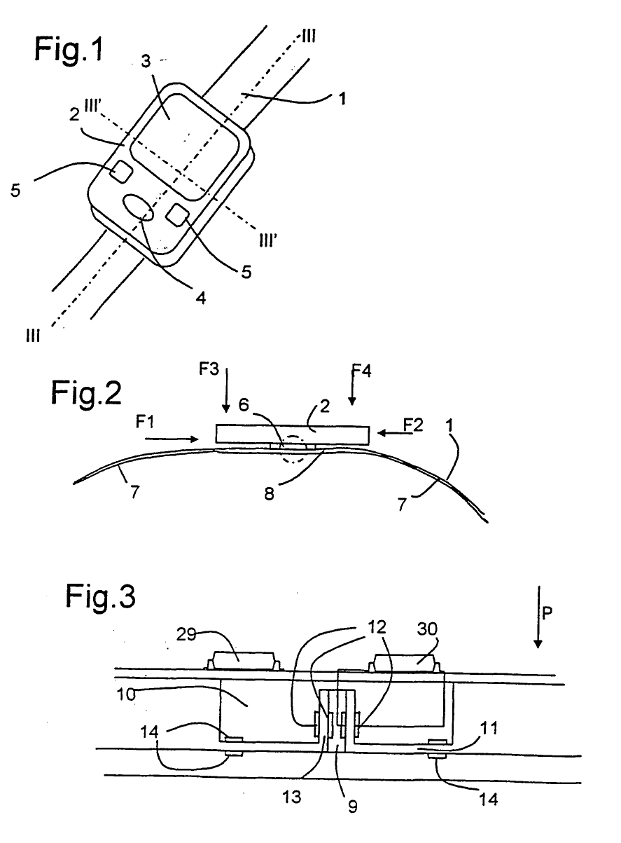

FIG. 1 shows a perspective view of a miniaturized telecommunications device that is intended for wearing on the wrist of a user;

FIG. 2 shows a schematic side view of the telecommunications device of FIG. 1;

FIG. 3 shows an enlarged section through the connecting region between housing and base plate of the telecommunications device of FIG. 1;

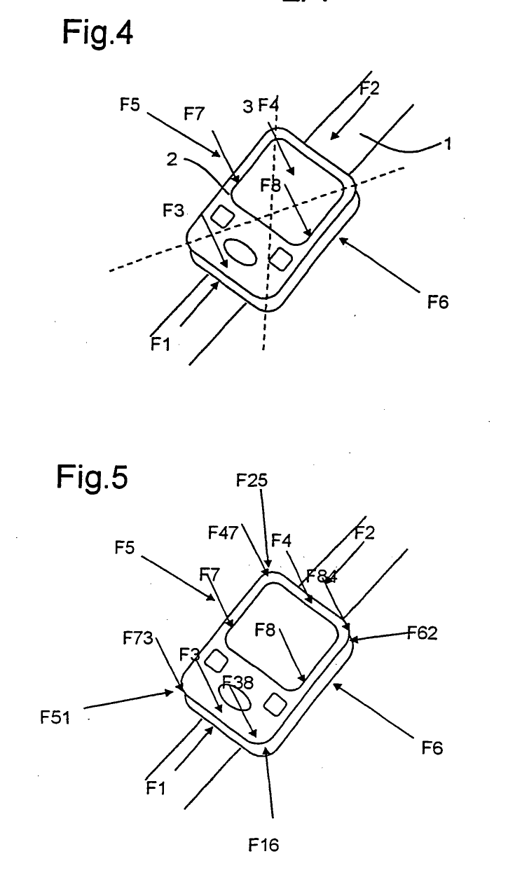

FIG. 4 shows a view of the telecommunications device of FIG. 1 indicating the detectable forces according to a first embodiment;

FIG. 5 shows a view similar to FIG. 4, which indicates the detectable forces according to a second embodiment;

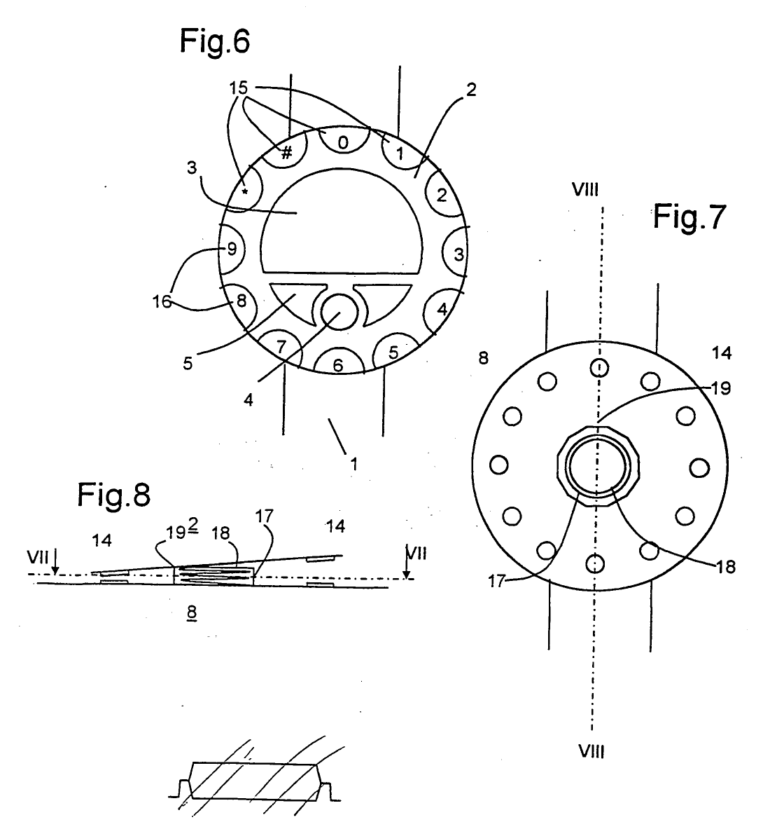

FIG. 6 shows a plan view of a second exemplary embodiment of a telecommunications device according to the invention;

FIG. 7 shows a schematic horizontal section through the telecommunications device of FIG. 6 along a gap 11 similar to that shown in FIG. 3;

FIG. 8 shows a section along the line VIII-VIII of FIG. 7;

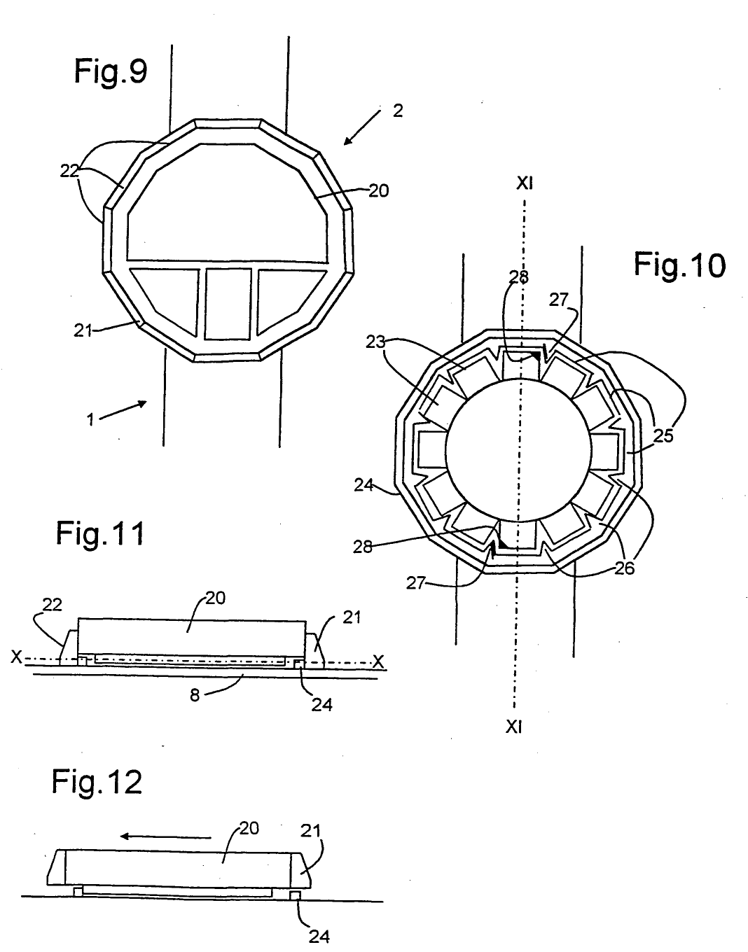

FIG. 9 shows a plan view of a third embodiment of a telecommunications device according to the invention;

FIG. 10 shows a horizontal section through the telecommunications device of FIG. 9 similar to the section of FIG. 7;

FIG. 11 shows a section along the line XI-XI of FIG. 10 in a state of the telecommunications device in which it is secured against movement; and

FIG. 12 shows a section similar to that of FIG. 11 in a state in which movement of the telecommunications device is possible.

FIG. 1 shows a perspective view of the telecommunications device according to the invention. It comprises a bracelet 1 (only part of which is shown in FIG. 1) having the same design and function as a traditional watch strap. A housing 2 containing the electronic components of the telecommunications device and a battery is fastened to this bracelet 1. On the viewing face of the housing 2 facing the user is arranged a display screen 3, e.g. a liquid crystal display, for displaying the operating state, for a phone number dialed by the user or the phone number of a caller, the phone numbers stored in an internal address book of the telecommunications device, etc. In addition, a hole in the housing for a microphone 4 is shown together with two function buttons 5. A loudspeaker can be integrated in the housing 2, and there is also the option to connect a set of headphones or earphones to the telecommunications device via a connector (not shown) . The function buttons 5 can be used e.g. for switching the device on and off and for receiving an incoming call.

As the side view of FIG. 2 shows, the housing 2 is connected via a short shaft 6 to an area of the bracelet that is shown thicker here than the sections 7 of the bracelet 1 lying on either side, and whose shape is designed to fit the cross-section of the arm of the user so that on the arm it is secured against unhindered tilting. This section is designated the base plate 8.

FIG. 3 shows in enlarged scale an example of a possible structure of the shaft 6. The shaft 6 comprises here a central, slightly flexible pin 9 connecting base plate 8 and housing 2. The pin 9 is surrounded by a hollow cylinder-shaped ring 10 permanently connected to the housing 2 and separated from the base plate 8 by a gap 11.

Of course the ring 10 could also equivalently be connected to the base plate 8 and be separated from the housing 2.

The pin 9 and the ring 10 carry pairs of facing electrodes 12, each pair forming a capacitor whose capacitance depends on the width of the air gap 13 between the pin 9 and the ring 10. If the user exerts a force on the housing 2 towards the left in the figure, then this causes the air gap 13 to the left of the pin 9 to widen, and the air gap 13 to the right of the pin 9 to narrow. The change in the capacitances resulting from this can be detected using a suitable measurement circuit 30. The measurement circuit 30 thus forms together with the electrodes 12 a sensor for a force exerted on the housing 2 towards the left (or towards the right) in FIG. 3.

Additional pairs of electrodes 14 are each arranged to face each other on the ring 10 and the base plate 8. If a force is exerted on the housing 2 at an offset to the axis of the pin 9, e.g. in the direction of the arrow P, then this leads to a turning moment and bending of the pin 9, with the result that the distance between the right pair of electrodes 14 reduces, and increases between the left pair of electrodes 14. The change in capacitance resulting from this is also detectable by the measurement circuit 30 or a second, similar measurement circuit, which thus together with the electrodes 14 forms a turning-moment sensor.

Although a turning moment exerted on the housing 2 also causes a change in the gaps between the electrodes 12, this change is smaller than if a force producing displacement of the housing 2 is exerted tangentially to the base plate 8. Using the ratio of the measured capacitance changes of the electrode pairs 12 and 14, a processor 29 receiving the output signals from the measurement circuits 30 is able to discriminate between a turning moment exerted by the user about a rotational axis parallel to the base plate 8 and a displacement force parallel to the base plate 8, i.e. the processor 29, using the signals supplied by the measurement circuit 30, is able to distinguish whether the user is exerting a displacement force F1 or F2 (see FIG. 2) on one side of the housing, or whether he is pressing from above onto the housing 2 to the right or left of the shaft 6, corresponding to forces F3 or F4. Hence each of these four operating forces F1 to F4 can activate a different function of the telecommunications device.

The electrode pairs 12, 14 forming the capacitors can be replaced equivalently by piezo-elements in conjunction with a suitable measuring circuit. Switch contacts can also be used.

FIG. 3 shows a section along the line labeled in FIG. 1 with III-III. In addition, a similar arrangement of electrodes 12 and 14 can be provided, e.g. rotated by 90° in a section along the line III′-III′ in FIG. 1. This enables the processor to distinguish at least eight different operating forces, namely, as shown in FIG. 4, each of the forces F1, F2, F5, F6 exerted on side faces of the housing, and each of the forces F3, F4, F7, F8 exerted on four different quadrants of the viewing face of the housing 2.

If a force is exerted along one of the two delimiting lines shown dashed in FIG. 4, then this leads to gap changes, and hence measurement signals, of comparable size at pairs of electrodes 12 and 14 on the line III-III and III′-III′. It can be provided that the processor rejects such a combination of measurement signals as non-interpretable. The occurrence of such a combination of measurement signals can, however, also be interpreted by the processor as a request by the user for another function of the telecommunications device, i.e. the processor is able to distinguish between a total of 16 forces exerted in different directions on the side edge of the housing 2, or in different locations on the viewing face of the housing, and to activate different functions according to the type of force exerted. FIG. 5 shows an example of the orientation or spatial distribution of these forces.

FIG. 6 shows a plan view of a second exemplary embodiment of the telecommunications device according to the invention. As in the exemplary embodiment of FIG. 1, the housing 2 has a display screen 3, a microphone 4 and two function buttons 5. On the viewing face of the circular housing facing the user, twelve marks or markings 15 are evenly distributed around the outer edge. The markings 15 can be designed as small projections or recesses of the housing, they can be colored to contrast with the rest of the housing 2, or they can also simply be formed by a printed symbol 16. The symbols 16 designate the digits 0 to 9 and two symbols common on conventional phone keypads, the star and hash. The digits 0 to 9 are arranged like the numbers on a clock face, the digit 0 being placed in the 12 O'clock position.

As in the telecommunications device of FIG. 1, the housing 2 is separated from a base plate 8 by a gap 11 (which is shown in FIG. 3). FIG. 7 shows a section through the telecommunications device of FIG. 6 at the height of this gap 11 (which is similar to that shown in FIG. 3). Twelve electrodes 14 (of which one is labeled in the figure for representation) are evenly distributed in a circle on the base plate 8. In the center of the circular arrangement of the electrodes 14 there is a ring 17 whose outer contour has the form of a regular dodecagon, and whose hollow interior accommodates a strong coil spring 18 or another suitable flexible element. The twelve rectilinear segments of the circumference of the ring 17 each face one of the electrodes 14.

FIG. 8 shows a section along the line VIII-VIII of FIG. 7 in a state in which a user is pressing on the “0”-labeled marking 15 of the housing 2. The housing 2 is tilted out of a rest position, in which the base plate 8 and housing 2 lie parallel to each other and the housing 2 lies on the complete circumference of the ring 17, into a position in which the electrodes 14 adjacent to the “0” marking are positioned closer together, while the electrodes 14 adjacent to the “6” marking are moved away from each other, the housing 2 is touching the ring 17 solely in the area of its edge 19 facing the “0” marking, and the coil spring 18 is stretched. The twelve-sided outer shape of the ring 17 ensures that the housing 2 only tilts about one of a total of twelve possible axes at any one time, so that in the case illustrated here, the drawing closer of the electrodes 14 adjacent to the “0” marking is detectably stronger that that of the electrodes adjacent to the “1” marking or “#” marking respectively. By comparing the signals supplied by the measurement circuits of the various electrodes 14, the processor can reliably detect which of the various markings 15 a user has pressed.

In this embodiment, it is also possible to replace each pair of electrodes 14 with suitably positioned switch contacts, of which, when a user presses on a marking 15, only the switch contact nearest to the marking is ever closed at one time.

FIG. 9 shows a plan view of a third embodiment of the telecommunications device according to the invention similar to that of FIG. 6. The elements 3, 4, 5 on the viewing face of the housing 2 are the same as in the embodiments of FIG. 1 and 6. As can be seen particularly in the sections of FIG. 11 and 12, the housing 2 is made of a main body 20 and a ring 21 surrounding the main body that can be displaced normal to the plane of FIG. 9, that is upwards and downwards in FIG. 12. The ring 21 has twelve beveled edges 22 on its outer surface. Each of these beveled edges 22, like the markings 15 in the embodiment of FIG. 6, is either assigned to one of the digits 0 to 9, or to the * or # function.

FIG. 10 shows a section through the telecommunications device of FIG. 9 along the line X-X of FIG. 11. One can see that in its lower area the main body 20 has a cross-section in the form of a star with twelve blunt points 23, which is surrounded, with clearance, by a ring 24 connected to the base plate 8. The inner face of the ring 24 is formed by twelve rectilinear segments 25, each of which is separated by inward pointing points 26.

In the position shown in FIG. 11, the ring 21 surrounds, with substantially no clearance, both the main body 20 and the ring 24 connected to the base plate 8. In this position, the main body 20 cannot move with respect to the base plate 8.

FIG. 12 shows the ring 21 in a raised position in which it no longer surrounds the ring 24. In this position of the ring, the housing 2 can be displaced parallel to the base plate 8, as indicated by an arrow in the figure. As a result of the displacement, one of the blunt points 23 of the main body 20 can be brought into contact with an opposite rectilinear segment 25 of the ring 24 at any one time, and so make electrical contact between points 23 and segment 25. Points 23 and segment 25 thus form a sensor for a displacement of the housing 2 with respect to the fastening element 1. The width and length of the inward pointing points 26 of the ring 24 are specified so that at any point in time only one blunt point 23 can ever be touching the opposite segment 25. Thus by successive pressing against several beveled edges 22 in turn, a user can close several contacts and hence e.g. dial a phone number.

A spring element that, after every closure of a contact and release of the housing 2, returns the housing 2 to a central position in which it is not touching the ring 24, is present but is not shown in the figure for the sake of clarity.

According to a preferred further development, the housing 2 can be moved not only parallel to the base plate 8, but can also be rotated against the force of a spring about an axis normal to the base plate 8. Such a rotation results in the sides of the blunt points 23 of the main body 20 each coming into contact with one or the other edge of the inward pointing points 26 of the ring 24, and in this way closing an electrical contact of a switch serving as sensor for a rotation. As shown in FIG. 10 as an example, such a switch or sensor can be built on one side from two sides 27 of the diametrically opposed points 26 of the ring 24, said sides being connected together by a conductor, and from electrodes 28 lying opposite to these sides on the blunt points 23, a voltage being applied to said electrodes.

Using the sensor formed from these sides and electrodes 27, 28, it is possible to detect a clockwise rotation; a mirror-symmetrical arrangement of sides and electrodes, which is not shown for the sake of clarity, is used to detect counter-clockwise rotation.

Detection of a rotation in one of two directions can be used by the processor, for instance to scroll forwards or backwards through an address book displayed on the display screen 3, or even to correct the incorrectly entered digits of a phone number by incrementing or decrementing in steps.

1. A telecommunications device comprising a fastening element (1) for fastening the device on a support, and a housing (2), characterized by at least one sensor (12, 30; 14, 30; 23, 25; 27, 28) for detecting a movement between the housing (2) and the fastening element (1), and a processor (29) for controlling the function of the telecommunications device according to the movement detected by the sensor (12, 30; 14, 30; 23, 25; 27, 28):

2. The telecommunications device as claimed in claim 1, in which the sensor of which there is at least one (12, 30; 14, 30; 23, 25; 27, 28) detects the movement in the form of a force acting between the housing (2) and the fastening element (1).

3. The telecommunications device as claimed in claim 1 or 2, characterized in that it comprises a plurality of sensors for detecting forces and/or turning moments in a plurality of spatial directions.

4. The telecommunications device as claimed in claim 1, 2 or 3, characterized in that the housing (2) is connected to a base plate (8) of the fastening element (1), and a sensor (27, 28) for detecting a turning moment about an axis normal to the base plate and/or one or more sensors (12, 30; 14, 30) for detecting a turning moment about one or more axes parallel to the base plate is/are provided.

5. The telecommunications device as claimed in claim 1, 2, 3 or 4, characterized in that the housing (2) is connected to a base plate (8) of the fastening element (1), and one or more sensors (12, 30; 23, 25) for detecting a displacement of the housing (2) relative to the base plate (8) are provided.

6. The telecommunications device as claimed in claim 5, characterized by means (21) to lock the displacement of the housing (2).

7. The telecommunications device as claimed in claim 6, characterized in that the sensor (23, 25; 27, 28) is a switch contact.

8. The telecommunications device as claimed in one of the claims 1 to 6, characterized in that it has a plurality of sensors (12, 30; 14, 30) supplying a quantitative signal, and that the processor (29) is set up to determine a quantitative ratio of the signals supplied by the sensors.

9. The telecommunications device as claimed in one of the preceding claims, characterized in that markings (15) assigned to the digits 0 to 9 are made on the edge of a face of the housing that faces away from the fastening element.

10. The telecommunications device as claimed in one of the preceding claims, characterized in that the fastening element (1) is a bracelet.
